(19) United States
(12) Patent Application Publication
(10) Pub. No.: US 2009/0280406 A1
(43) Pub. Date: Nov. 12, 2009

(54) SECONDARY BATTERY

(76) Inventor: Kiyomi Kozuki, Osaka (JP)

Correspondence Address: MCDERMOTT WILL & EMERY LLP, 600 13TH STREET, NW, WASHINGTON, DC, 20005-3096, US

(21) Appl. No.: 11/915,632

(22) PCT Filed: May 24, 2007
(86) PCT No.: PCT/JP2007/060594

§ 371 Date: Nov. 27, 2007

(30) Foreign Application Priority Data
Jun. 2, 2006 (JP) 2006-154268

(51) Int. Cl. H01M 4/02

(52) U.S. Cl. 429/209

(57) ABSTRACT

A secondary battery comprising at least an electrode assembly having a positive electrode plate, a negative electrode plate and a porous insulation layer arranged in a manner that an exposed portion of a current collector provided at one edge of at least one of the positive electrode plate and the negative electrode plate protrudes from the porous insulation layer, current collector members each connected to respective one of the positive electrode plate and the negative electrode plate, and a bend preventing part whose size smaller than a width of the exposed portion of the current collector, provided in a position of the exposed portion of the current collector.

### TECHNICAL FIELD

The present invention relates to a secondary battery devised to achieve a high power, and in particular, to a current collecting structure having a low resistance suitable for charging and discharging a large electric current.

### BACKGROUND ART

With the advancement in recent years of downsizing and weight reduction of various electric apparatuses, many efforts are being made to develop secondary batteries for providing electric sources to power them, as one of the important key devices. Certain secondary batteries such as nickel hydrogen batteries and lithium ion batteries among the batteries of many kinds are evolving widely of their applications in a variety of fields from consumer appliances including mobile phones to electric vehicles as well as driving sources of power tools because of their features of light weights, small sizes and high energy densities. In particular, lithium ion batteries recently gain attention as driving power sources, and their development is becoming active toward higher capacities and higher power outputs.

Since the batteries used as driving power sources are required to have large output currents and large capacities, numerous ideas have been proposed for battery structures, especially for current collecting structures incorporated in the batteries.

To maximize an electrode area and to obtain a large output current, an electrode assembly typically employs a structure comprising a positive electrode plate made of a positive electrode current collector coated with a positive electrode activator composite and a negative electrode plate made of a negative electrode current collector coated with a negative electrode activator composite, wherein the current collectors are wound in a confronting manner with a separator interposed between them. This electrode assembly is housed in a cylindrical battery case serving one of the battery terminals, and an opening of the battery case is sealed with a sealing plate serving the other of the battery terminals, to hence complete the secondary battery. Usually, the negative electrode current collector and the positive electrode current collector are electrically connected respectively to the battery case and the sealing plate either directly or through current collector members such as current collecting plates, current collecting tabs, lead plates or the like elements in a manner to reduce their connecting resistances to an optimum extent as possible.

In addition, it is necessary to reduce volumes occupied by the individual current collectors so as to increase amounts of the positive electrode activator composite and the negative electrode activator composite as much extent as possible in order to obtain a higher storage capacity of the secondary battery. For this purpose, a thin metal foil of about ten-odd μm in thickness is used for each of the current collectors.

It is also necessary to employ such a current collecting structure that provides low resistances in the connections of the individual current collectors with the battery case and the sealing plate, distributes the electric currents uniformly over the entire areas of the positive and negative electrode plates, and reduces volumes of the connecting parts occupying a space inside the battery.

A secondary battery disclosed hitherto has a tab-less structure shown in FIG. 10, FIG. 11A and FIG. 11B, as one such current collecting structure that satisfies the above requirements (refer to patent document 1, for example).

That is, the secondary battery comprises positive electrode plate 51 having positive electrode activator composite uncoated area 51a welded to positive electrode current collector member 60, negative electrode plate 52 having negative electrode activator composite uncoated area 52a welded to negative electrode current collector member 61, and battery case 62 housing the electrode assembly, shown in FIG. 10. In this tab-less structure, negative electrode current collector member 61 is connected to the inner bottom of battery case 62, and positive electrode current collector member 60 is connected to sealing plate 63.

Because of this structure, positive electrode plate 51 shown in FIG. 11A and negative electrode plate 52 shown in FIG. 11B are provided with positive electrode activator composite uncoated area 51a and negative electrode activator composite uncoated area 52a respectively formed along the longitudinal direction at one of the lateral sides. Positive electrode plate 51 and negative electrode plate 52 are so positioned that positive electrode activator composite uncoated area 51a and negative electrode activator composite uncoated areas 52a are in opposite orientations to each other with their edges staggered vertically for instance, and they are wound with separator 53 interposed therebetween, so as to compose the electrode assembly having positive electrode activator composite uncoated area 51a and negative electrode activator composite uncoated areas 52a protruding from the edges of separator 53. As used herein, the term “positive electrode activator composite uncoated area” means an exposed portion of the positive electrode current collector of the positive electrode plate, and the term “negative electrode activator composite uncoated area” means an exposed portion of the negative electrode current collector of the negative electrode plate.

The protruding edges of the electrode assembly composed above are bent one after another from the periphery toward the winding axis to form surfaces that come into contact with positive electrode current collector member 60 and negative electrode current collector member 61, which are then welded to these surfaces.

It is said here that this structure makes distribution of electric currents uniform within positive electrode plate 51 and negative electrode plate 52, and improves a charging and discharging characteristic.

However, it does not provide a sufficient physical strength when thin foils are used for the current collectors in order to obtain a high capacity. Therefore, in the structure wherein the exposed edges of the current collectors are bent one after another and welded to the current collector members, as disclosed in the patent document 1, there is a drawback that the current collectors cannot be bent uniformly, and distortions formed around the activator composite coated areas cause separation of the activator composites off the current collectors or damage the composites.

There is hence disclosed another current collecting structure, in which positive electrode activator composite uncoated area 71a of positive electrode plate 71 and negative electrode activator composite uncoated area 72a of negative electrode plate 72 are folded at their lateral edges to improve their physical strength, as shown in FIG. 12A and FIG. 12B (for example, refer to patent document 2).

However, this current collecting structure of folding the positive electrode activator composite uncoated area and the negative electrode activator composite uncoated area, as disclosed in the patent document 2, does not change the thickness of the current collectors around the boundaries between the activator composite coated area and the uncoated area although it improves the physical strength of the folded portions where the thickness is increased. As a result, the current collectors are liable to deform in the boundaries of the activator composite coated areas due to their still weak physical strength to the stresses. This results in distortions in the activator composite coated areas, thereby leaving the problem of causing separation of the activator composites off the current collectors.

In this patent specification, certain components related to both the positive electrode plate and the negative electrode plate may be referred to simply as electrode plate, activator composite coated area, activator composite uncoated area (or exposed portion), current collector, current collector member and the like when they need not be distinguished specifically.

Patent Document 1: Japanese Patent Unexamined Publication, No. 2000-323117; and

Patent Document 2: Japanese Patent Unexamined Publication, No. H4-324248.

### SUMMARY OF THE INVENTION

A secondary battery of the present invention has a structure comprising at least an electrode assembly of a positive electrode plate, a negative electrode plate and a porous insulation layer arranged in a manner that an exposed portion of a current collector provided at one edge of at least one of the positive electrode plate and the negative electrode plate protrudes from the porous insulation layer, current collector members connected to the positive electrode plate and the negative electrode plate respectively, and a bend preventing part whose size smaller than a width of the exposed portion of the current collector, provided in a position of the exposed portion of the current collector.

This structure improves a strength of the exposed portion of the current collector protruding from the electrode assembly, and prevents irregular bending of the exposed portion due to a stress applied thereto during connection to the current collector member, thereby achieving a highly reliable tab-less structure. The structure also prevents an activator composite from coming off the current collector to achieve the highly reliable tab-less structure, so as to realize a secondary battery capable of charging and discharging a large current.

### BRIEF DESCRIPTION OF DRAWINGS

FIG. 1A is a sectional general view of a secondary battery according to a first exemplary embodiment of the present invention;

FIG. 1B is an enlarged view of a portion marked “B” in FIG. 1A;

FIG. 1C is an enlarged view of another portion marked “C” in FIG. 1A;

FIG. 2A is an expanded view of a positive electrode plate used in the first exemplary embodiment;

FIG. 2B is an expanded view of a negative electrode plate used in the first exemplary embodiment;

FIG. 3A is a perspective view illustrating an example of a spring member used in the first exemplary embodiment;

FIG. 3B is a perspective view illustrating another example of the spring member used in the first exemplary embodiment;

FIG. 4A is a sectional view illustrating a structure of an electrode assembly provided with a bend preventing part according to a second exemplary embodiment of the present invention;

FIG. 4B is a sectional view of a current collector member having the bend preventing part used in the second exemplary embodiment;

FIG. 5A is a perspective view illustrating a structure of an electrode assembly of a secondary battery according to a third exemplary embodiment of the present invention;

FIG. 5B is an enlarged perspective view of a part of the electrode assembly shown in FIG. 5A;

FIG. 6A is a perspective view illustrating a structure of an electrode assembly of a secondary battery according to a fourth exemplary embodiment of the present invention;

FIG. 6B is an enlarged perspective view of a part of the electrode assembly shown in FIG. 6A;

FIG. 7A is a perspective view illustrating a structure of an electrode assembly of a secondary battery according to a fifth exemplary embodiment of the present invention;

FIG. 7B is an enlarged perspective view of a part of the electrode assembly shown in FIG. 7A;

FIG. 8A is an expanded view of a positive electrode plate of a secondary battery according to a sixth exemplary embodiment of the present invention;

FIG. 8B is an expanded view of a negative electrode plate according to the sixth exemplary embodiment;

FIG. 9 is a sectional view showing a structure of the secondary battery according to the sixth exemplary embodiment;

FIG. 10 is a drawing illustrating a conventional secondary battery having a tab-less structure;

FIG. 11A is an expanded view of a positive electrode plate of the secondary battery shown in FIG. 10;

FIG. 11B is an expanded view of a negative electrode plate of the secondary battery shown in FIG. 10;

FIG. 12A is a perspective view illustrating a current collecting structure of the positive electrode plate of the conventional secondary battery; and

FIG. 12B is a perspective view illustrating a current collecting structure of the negative electrode plate of the conventional secondary battery.

### REFERENCE MARKS IN THE DRAWINGS

1 positive electrode plate
2 negative electrode plate
3 separator (porous insulation layer)
4 electrode assembly
5a positive electrode activator composite uncoated area
5b positive electrode activator composite coated area
6a negative electrode activator composite uncoated area
6b negative electrode activator composite coated area
7 inner diameter retainer
8 ring frame
9 spring member
10 positive electrode current collector member
11 negative electrode current collector member
12 battery case
13 insulation sheet
14 sealing plate
15 gasket
16 rib
17 shrinkable ring band
18 clamping band
19 push-nut type ring
20 projecting part
21 reinforcing layer

### DETAILED DESCRIPTION OF PREFERRED EMBODIMENTS

Referring now to the accompanying drawings, description is provided hereinafter of exemplary embodiments of the present invention. Here, the description is provided by using examples of nonaqueous electrolyte secondary batteries such as lithium ion batteries. The description is therefore not to be taken in a limited sense, but the invention may be embodied or practiced in still many other ways as long as they conform to the essential character described in the following specifications.

### First Exemplary Embodiment

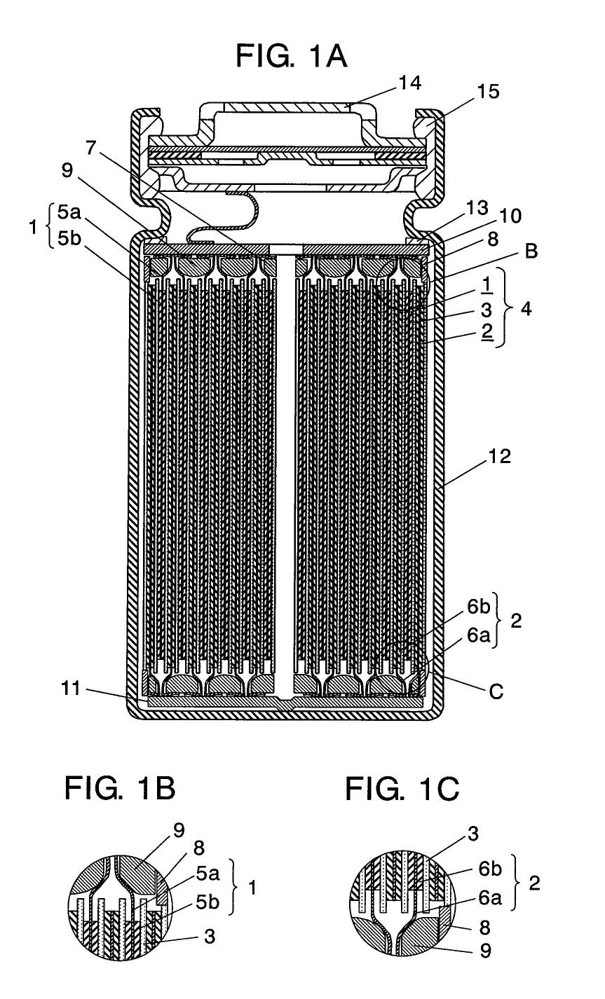

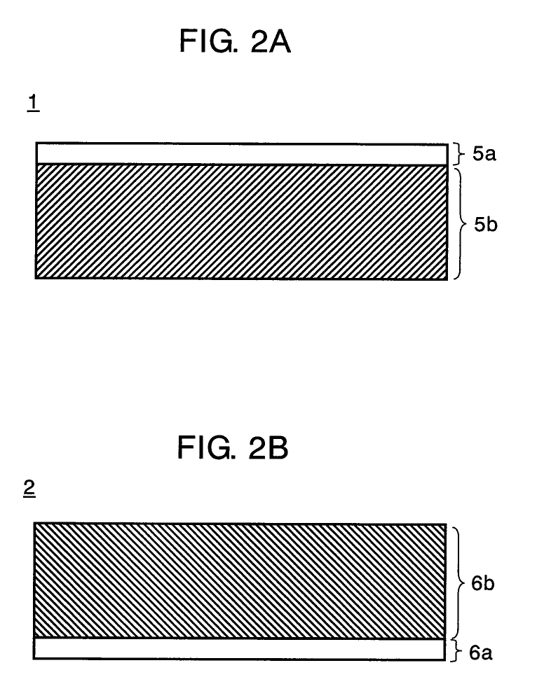

FIG. 1A is a sectioned general view of a secondary battery according to the first exemplary embodiment of the present invention, FIG. 1B is an enlarged view of a portion marked “B” in FIG. 1A, and FIG. 1C is an enlarged view of another portion marked “C” in FIG. 1A. FIG. 2A is an expanded view of a positive electrode plate used in this exemplary embodiment, and FIG. 2B is an expanded view of a negative electrode plate also used in this exemplary embodiment.

In FIG. 1A to FIG. 1C, the nonaqueous electrolyte secondary battery of a cylindrical shape (hereinafter referred to as “battery”) is provided with electrode assembly 4, which comprises positive electrode plate 1 having a positive electrode activator composite coated on a positive electrode current collector made of an aluminum foil for instance, negative electrode plate 2 having a negative electrode activator composite coated on a negative electrode current collector made of a copper foil for instance, and porous insulation layer 3 (referred to as “separator”) made of a micro-porous film of 25 μm thick polypropylene resin for instance, interposed between positive electrode plate 1 and negative electrode plate 2, wherein positive electrode plate 1, negative electrode plate 2 and separator 3 are spirally wound together.

In this embodiment here, positive electrode plate 1 is provided with positive electrode activator composite uncoated area 5a formed in a stripe shape along the longitudinal direction at one of the lateral sides of the positive electrode current collector, and positive electrode activator composite coated area 5b, as shown in FIG. 2A.

Negative electrode plate 2 is provided with negative electrode activator composite uncoated area 6a also formed in a stripe shape along the longitudinal direction at one of the lateral sides of the negative electrode current collector, and negative electrode activator composite coated area 6b, as shown in FIG. 2B. Here, positive electrode activator composite uncoated area 5a and negative electrode activator composite uncoated area 6a represent exposed portions of the current collectors, where the positive electrode current collector and the negative electrode current collector are exposed, and that they are so named respectively in order to help distinguish them easily. Electrode assembly 4 is so constructed that positive electrode plate 1 and negative electrode plate 2 are wound with at least separator 3 interposed between positive electrode activator composite coated area 5b and negative electrode activator composite coated areas 6b, in a manner to protrude positive electrode activator composite uncoated area 5a and negative electrode activator composite uncoated area 6a in the directions opposite to each other beyond the edges of separator 3.

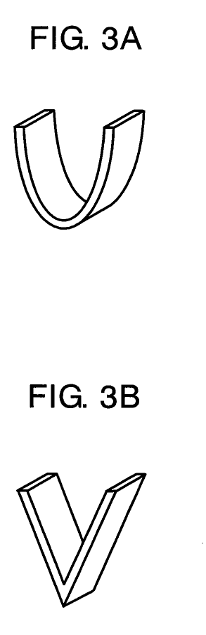

Electrode assembly 4 is also provided with inner diameter retainer 7 made of a resin material, for instance, in the winding axis thereof, and ring frame 8 fitted to the outer periphery of wound electrode assembly 4 to restrict the positions of positive electrode activator composite uncoated area 5a and negative electrode activator composite uncoated area 6a protruding from separator 3. In addition, electrode assembly 4 is provided with spring members 9 of a wedge-like shape resembling the letter of U or V, as shown for example in FIG. 3A and FIG. 3B, disposed in intermediate positions of positive electrode activator composite uncoated area 5a and negative electrode activator composite uncoated area 6a wound between inner diameter retainer 7 and ring frame 8, at least under the surfaces of a positive electrode current collector member and a negative electrode current collector member, which will be discussed later.

It is desirable here that spring members 9 are made of a plastic resin material such as polycarbonate resin, which has an exceptionally good elasticity and resistance to chemicals. When metals are used to fabricate spring members 9, it is desirable to use aluminum for the spring members disposed in the positive electrode activator composite uncoated area where the positive electrode current collector is exposed, and copper or nickel for the spring members disposed in the negative electrode activator composite uncoated area where the negative electrode current collector is exposed, since these metals are low in reactivity to the positive electrode plate and the negative electrode plate respectively while providing high electrical conductivities.

It is important that heights of inner diameter retainer 7, ring frame 8 and spring members 9 are smaller than widths of positive electrode activator composite uncoated area 5a and negative electrode activator composite uncoated area 6a. The reason of this is because activator composite uncoated areas 5a and 6a cannot be connected with their respective current collector members if the heights are larger.

Positive electrode current collector member 10 and negative electrode current collector member 11 are welded to make electrical connections with respective ones of positive electrode activator composite uncoated area 5a and negative electrode activator composite uncoated area 6a of electrode assembly 4 at least in locations where spring members 9 are disposed. The welding between the current collectors and the current collector members may be made by any such methods as arc welding (e.g., TIG, or tungsten inert gas welding), laser welding, and electron beam welding. Electrode assembly 4 provided with positive electrode current collector member 10 and negative electrode current collector member 11 is then housed inside battery case 12, negative electrode current collector member 11 is connected to the bottom of battery case 12, and positive electrode current collector member 10 is connected to sealing plate 14 with insulation sheet 13 interposed between them. After battery case 12 is filled with a nonaqueous electrolyte material, it is crimped and closed with sealing plate 14 through gasket 15.

In the structure described above, positions of the positive electrode activator composite uncoated area and the negative electrode activator composite uncoated area are aligned collectively while being restricted of their positions and heights by inner diameter retainer 7, ring frame 8 and spring members 9, thereby providing the secondary battery having improved physical strength.

According to the first exemplary embodiment, the present invention prevents the positive electrode current collector and the negative electrode current collector, as indicated by the positive electrode activator composite uncoated area and the negative electrode activator composite uncoated area, from being bent when they are connected with the positive electrode current collector member and the negative electrode current collector member, so as to lend it to uniform connections. In addition, the invention provides the secondary battery of uniform battery characteristics with high productivity since it can achieve a fixed height of the electrode assembly by virtue of the inner diameter retainer, the ring frame and the spring members.

The positive electrode current collector used here may be made of a thin metallic foil such as an aluminum foil or a perforated aluminum foil. Aluminum or the like material is also used for the positive electrode current collector member.

The positive electrode activator composite comprises a positive electrode active material, a conductive material and a binder. More specifically, the positive electrode active material may be one of several complex oxides such as lithium cobalt oxide, lithium nickel oxide, lithium manganese oxide, and denatured compounds thereof. Any of elements such as aluminum and magnesium can be included as a denaturant. Additionally, such elements as cobalt, nickel and manganese may also be admixed to the positive electrode active material. Materials such as graphite, carbon black and metal powder are suitable for use as the conductive material since they are stable under the electrical potential of the positive electrode. For the binder, any of poly-vinylidene fluoride (“PVDF”), poly-tetrafluoroethylene (“PTFE”), and the like materials is used since they are also stable under the potential of the positive electrode.

On the other hand, the negative electrode current collector may be made by using a thin metallic foil such as a copper foil or a perforated copper foil. A material such as nickel, copper or nickel plated copper can be used for the negative electrode current collector member.

The negative electrode activator composite comprises a negative electrode active material, a conductive material and a binder. More specifically, the negative electrode active material may be any selected from the group consisting of natural graphite, synthetic graphite, aluminum, an alloy composed mainly of aluminum, metal oxide such as tin oxides, metal nitride, and the like. Materials such as graphite, carbon black and metal powder are suitable for use as the conductive material since they are stable under the electrical potential of the negative electrode. For the binder, any of styrene butadiene copolymer rubber (“SBR”), carboxymethyl cellulose (“CMC”), and the like materials is used since they are also stable under the potential of the negative electrode.

Furthermore, a nonaqueous electrolyte solution or a gel electrolyte comprised of a polymer material containing a nonaqueous electrolyte solution can be used as the nonaqueous electrolyte material. Here, the nonaqueous electrolyte solution comprises a nonaqueous solvent, a solute and an additive. A lithium salt such as lithium hexafluorophosphate (“LiPF₆”) or lithium tetrafluoroborate (“LiBF₄”) can be used as the solute. Materials suitable for use as the nonaqueous solvent include, but not limited to, cyclic carbonates such as ethylene carbonate and propylene carbonate, and chain carbonates such as dimethyl carbonate, diethyl carbonate and ethyl-methyl carbonate. The nonaqueous solvent used here may be comprised of a single material or a combination of two or more kinds of these materials. For the additive, any of vinylene carbonate, cyclohexyl-benzene, diphenyl ether, and the like is used.

Description is provided hereinafter of a method of manufacturing the secondary battery according to the first exemplary embodiment of this invention.

First, a positive electrode activator composite is made by mixing the positive electrode active material of lithium cobalt oxide, the conductive material of graphite and the binder of poly-vinylidene fluoride (PVDF), for instance, which is then coated on a positive electrode current collector such as an aluminum foil. During this process, positive electrode activator composite uncoated area 5a is formed along a longitudinal direction at one of the lateral sides of the positive electrode current collector, to complete positive electrode plate 1.

Next, a negative electrode activator composite is made by mixing the negative electrode active material of natural graphite, the conductive material of graphite and the binder of styrene butadiene copolymer rubber (“SBR”) for instance, and this composite is coated on a negative electrode current collector such as a copper foil. Negative electrode activator composite uncoated area 6a is also formed during this process along a longitudinal direction at one of the lateral sides of the negative electrode current collector, to thus complete negative electrode plate 2.

Positive electrode plate 1 and negative electrode plate 2 are then wound with a separator made of a micro-porous membrane such as polyolefine interposed between them, in a manner that positive electrode activator composite uncoated area 5a and negative electrode activator composite uncoated area 6a protrude in the directions opposite to each other beyond their lateral sides, to thereby complete electrode assembly 4.

Next, bend preventing parts of the following structure are formed. That is, inner diameter retainer 7 made of a resin material, for instance, is inserted in the center of winding axis of positive electrode activator composite uncoated area 5a and negative electrode activator composite uncoated area 6a protruding from electrode assembly 4 in the directions opposite to each other. Ring frame 8 is fitted to the outer periphery of each of positive electrode activator composite uncoated area 5a and negative electrode activator composite uncoated area 6a. In addition, spring members 9 are inserted in positions intermediate between inner diameter retainer 7 and ring frame 8 at least under surfaces of positive electrode current collector member 10 and negative electrode current collector member 11 being disposed. The bend preventing parts comprised of inner diameter retainers 7, ring frames 8 and spring members 9 collectively align the positive electrode current collector and the negative electrode current collector as indicated by positive electrode activator composite uncoated area 5a and negative electrode activator composite uncoated area 6a, so as to reinforce the current collectors and to straighten their heights, etc.

Next, the aligned positive electrode activator composite uncoated area 5a and negative electrode activator composite uncoated area 6a are welded by means of TIG welding, for instance, to complete electrical connections with the positive electrode current collector member made of an aluminum plate or the like and the negative electrode current collector member made of a copper plate or the like, at their respective bend preventing parts.

Electrode assembly 4 provided with these current collector members is inserted into battery case 12 made of iron, nickel or stainless steel, for example, and the negative electrode current collector member is welded to the bottom of battery case 12 by means of resistance welding, for instance, to make an electrical connection therebetween. Likewise, the positive electrode current collector member is welded to sealing plate 14, also serving as a positive terminal, by means of laser welding for instance, to make an electrical connection therebetween.

Next, battery case 12 under a reduced pressure is filled with a nonaqueous electrolyte material comprised of a nonaqueous solvent such as ethylene carbonate and a solute such as lithium hexafluorophosphate (“LiPF₆”).

Subsequently, sealing plate 14 serving as the positive terminal is inserted into battery case 12, which is then crimped at the fringe around sealing plate 14 to hermetically seal it through gasket 15. Assembly of the secondary battery is hence completed.

### Second Exemplary Embodiment

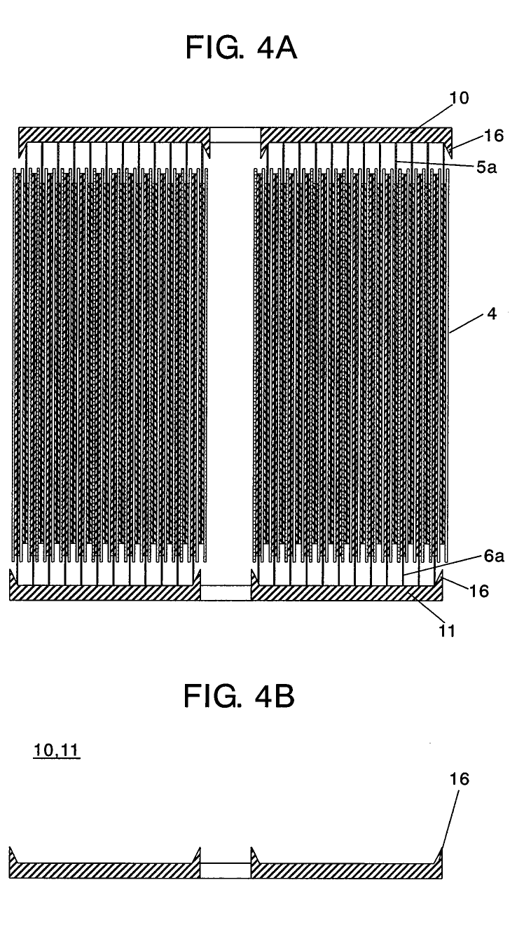

FIG. 4A is a sectional view illustrating a structure of an electrode assembly provided with a bend preventing part according to the second exemplary embodiment of this invention, and FIG. 4B is a sectional view of a current collector member provided with the bend preventing part used in this exemplary embodiment. The structure of the second embodiment differs from that of the first exemplary embodiment only in an aspect that the bend preventing part is combined with the current collector member, and that other components are analogous to each other.

That is, positive electrode current collector member 10 and negative electrode current collector member 11 are disposed to the end surfaces of electrode assembly 4, and that they are each provided with ribs 16 at positions corresponding to both the outer periphery and the inner periphery of electrode assembly 4 where they are fitted to exposed portions of electrode assembly 4, as shown in FIG. 4B. In this case, ribs 16 function as the bend preventing part. Positive electrode current collector member 10 and negative electrode current collector member 11 are welded to complete electrical connections with positive electrode activator composite uncoated area 5a and negative electrode activator composite uncoated area 6a of electrode assembly 4 respectively by means of TIG welding for instance, after they are fitted to electrode assembly 4 with their ribs 16 in the positions corresponding to the exposed portions of the current collectors. In other words, ribs 16 can align positions of the exposed portions of both the positive electrode current collector and the negative electrode current collector, thereby preventing them from being bent. Note that ribs 16 of positive electrode current collector member 10 and negative electrode current collector member 11 can be formed in a configuration along the periphery in the winding direction of electrode assembly 4, or even in a radial configuration thereof. The structure described above can provide the secondary battery similar to the first exemplary embodiment.

It is important to form ribs 16 to be smaller in height than a width of positive electrode activator composite uncoated area 5a and negative electrode activator composite uncoated area 6a, in order to make uniform connections of positive electrode activator composite uncoated area 5a and negative electrode activator composite uncoated area 6a with positive electrode current collector member 10 and negative electrode current collector member 11. That is, ribs 16 restrict the height of electrode assembly 4, and provide electrode assembly 4 of uniform configuration.

What has been illustrated in FIG. 4A is an example, in which ribs 16 are formed at the positions for fitting both the outer periphery and the inner periphery of electrode assembly 4. However, this should not be considered as restrictive, and that ribs 16 can be formed at any positions so long as they are effective for preventing the exposed portions of the current collectors from being bent.

In addition, the inner diameter retainer needs not be provided in the case of this second exemplary embodiment.

According to the second exemplary embodiment of this invention, ribs 16 prevent the positive electrode current collector and the negative electrode current collector, as indicated by positive electrode activator composite uncoated area 5a and negative electrode activator composite uncoated area 6a, from being bent when they are connected with positive electrode current collector member 10 and negative electrode current collector member 11, so as to attain uniform connections. In addition, this invention provides the secondary battery of stable battery characteristics with high productivity since ribs 16 can restrict the height of electrode assembly 4 and achieve a uniform configuration of electrode assembly 4.

### Third Exemplary Embodiment

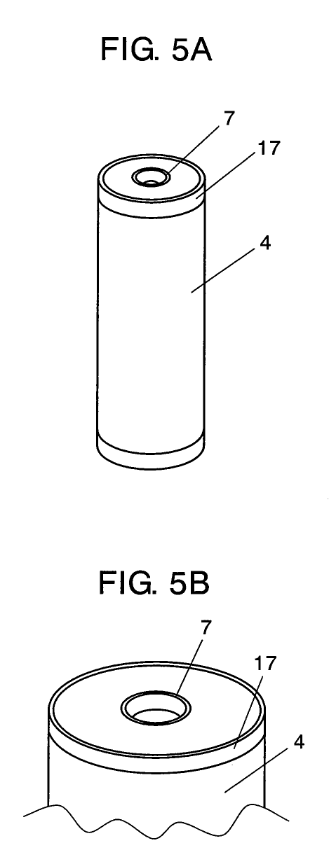

FIG. 5A is a perspective view illustrating a structure of an electrode assembly of a secondary battery according to the third exemplary embodiment of this invention, and FIG. 5B is an enlarged perspective view of a part of the electrode assembly shown in FIG. 5A. The structure of the third embodiment differs from that of the first exemplary embodiment only in the structure of bend preventing part, and other components are analogous to each other.

In other words, electrode assembly 4 is provided with shrinkable ring bands 17 made of a resin material for instance, attached to the outer peripheries of both a positive electrode activator composite uncoated area and a negative electrode activator composite uncoated area (not shown in the figures) protruding therefrom, as shown in FIG. 5A. Shrinkable ring bands 17 are then shrunk thermally to collectively align positive electrode activator composite uncoated area 5a and negative electrode activator composite uncoated area 6a, shown in FIG. 4A, to provide the bend preventing parts.

Shrinkable ring bands 17 used here may be made by using such materials as fluororesin, PFA, FEP, polyolefine and polyvinyl chloride, although there is no specific limitation on them.

Inner diameter retainer 7 used in this embodiment is preferably made of a material that does not shrink by heating, and more preferably of a material that rather expands.

According to the third exemplary embodiment of this invention, the positive electrode current collector and the negative electrode current collector, as indicated by the positive electrode activator composite uncoated area and the negative electrode activator composite uncoated area, are aligned collectively to improve their physical strength by way of shrinking shrinkable ring bands 17. As a result, shrinkable ring bands 17 prevent the positive electrode current collector and the negative electrode current collector from being bent when they are connected with the positive electrode current collector member and the negative electrode current collector member, so as to attain uniform connections. In addition, this invention provides the secondary battery of stable battery characteristics with high productivity since shrinkable ring bands 17 can restrict the height of electrode assembly 4 and achieve a uniform configuration of the electrode assembly.

### Fourth Exemplary Embodiment

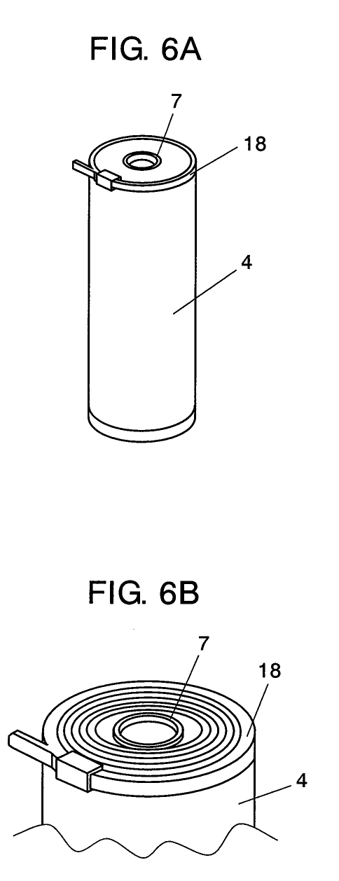

FIG. 6A is a perspective view illustrating a structure of electrode assembly 4 of a secondary battery according to the fourth exemplary embodiment of this invention, and FIG. 6B is an enlarged perspective view of a part of electrode assembly 4 shown in FIG. 6A. The structure of the fourth embodiment differs from that of the first exemplary embodiment only in the configuration of bend preventing part, and other components are analogous to each other.

In other words, electrode assembly 4 is provided with clamping bands 18 such as binding ties made of a resin material for instance, attached to the outer peripheries of both positive electrode activator composite uncoated area 5a and negative electrode activator composite uncoated area 6a protruding therefrom as shown in FIG. 6A. Tightening-up of clamping bands 18 collectively aligns positive electrode activator composite uncoated area 5a and negative electrode activator composite uncoated area 6a to provide the bend preventing parts.

Clamping bands 18 may be comprised of strings of thread or ribbon, which can be wound in a belt-like manner around electrode assembly 4, instead of the binding ties.

According to the fourth exemplary embodiment of this invention, the positive electrode current collector and the negative electrode current collector as indicated by the positive electrode activator composite uncoated area and the negative electrode activator composite uncoated area are aligned collectively to improve their physical strength by way of tightening clamping bands 18. As a result, clamping bands 18 prevent the positive electrode current collector and the negative electrode current collector from being bent when they are connected with the positive electrode current collector member and the negative electrode current collector member, so as to attain uniform connections. In addition, this invention provides the secondary battery of stable battery characteristics with high productivity since clamping bands 18 and inner diameter retainer 7 can restrict the height of electrode assembly 4 and achieve a uniform configuration of electrode assembly 4.

### Fifth Exemplary Embodiment

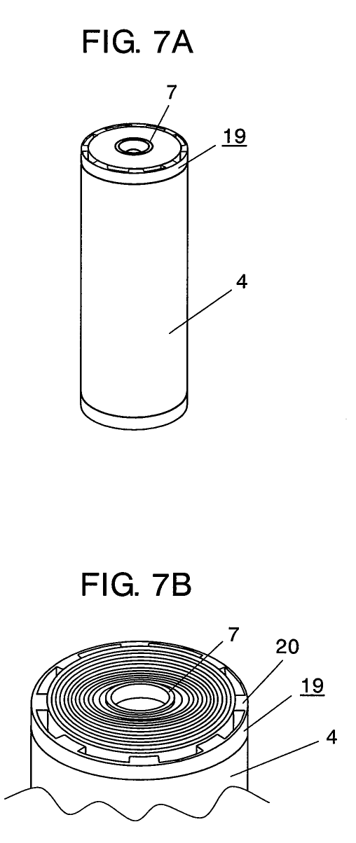

FIG. 7A is a perspective view illustrating a structure of an electrode assembly of a secondary battery according to the fifth exemplary embodiment of this invention, and FIG. 7B is an enlarged perspective view of a part of the electrode assembly shown in FIG. 7A. The structure of the fifth embodiment differs from that of the first exemplary embodiment only in the configuration of bend preventing part, and other components are analogous to each other.

In other words, electrode assembly 4 is provided with push-nut type rings 19 made of a resin material, for instance, attached to the outer peripheries of both a positive electrode activator composite uncoated area and a negative electrode activator composite uncoated area (not shown) protruding therefrom, as shown in FIG. 7A. Projecting parts 20 formed along the inner peripheries of push-nut type rings 19 collectively align positive electrode activator composite uncoated area 5a and negative electrode activator composite uncoated area 6a, shown in FIG. 4A, to provide the bend preventing parts.

According to the fifth exemplary embodiment of this invention, the positive electrode current collector and the negative electrode current collector, as indicated by the positive electrode activator composite uncoated area and the negative electrode activator composite uncoated area, are aligned collectively to improve their physical strength by projecting parts 20 on the inner peripheries of push-nut type rings 19. As a result, push-nut type rings 19 prevent the positive electrode current collector and the negative electrode current collector from being bent when they are connected with the positive electrode current collector member and the negative electrode current collector member, so as to attain uniform connections. In addition, this invention provides the secondary battery of stable battery characteristics with high productivity since push-nut type rings 19 and inner diameter retainer 7 can rectify variations of the height of electrode assembly 4 attributable to the bending and achieve a uniform configuration of electrode assembly 4.

### Sixth Exemplary Embodiment

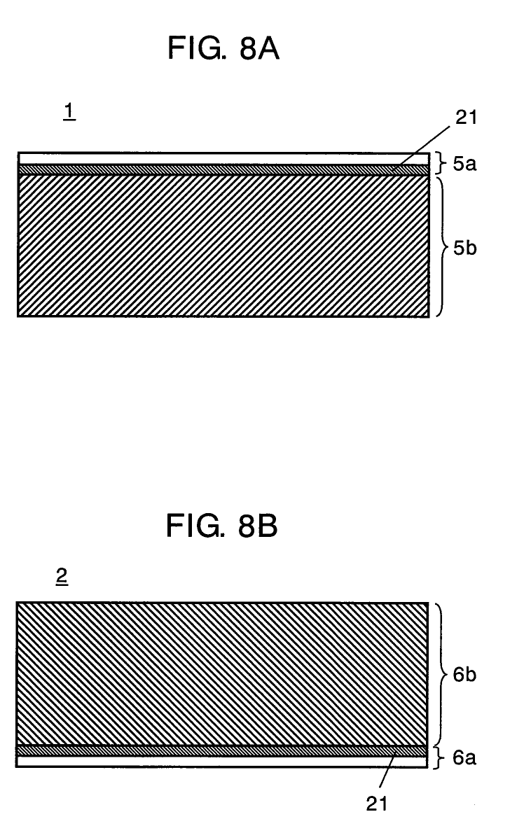

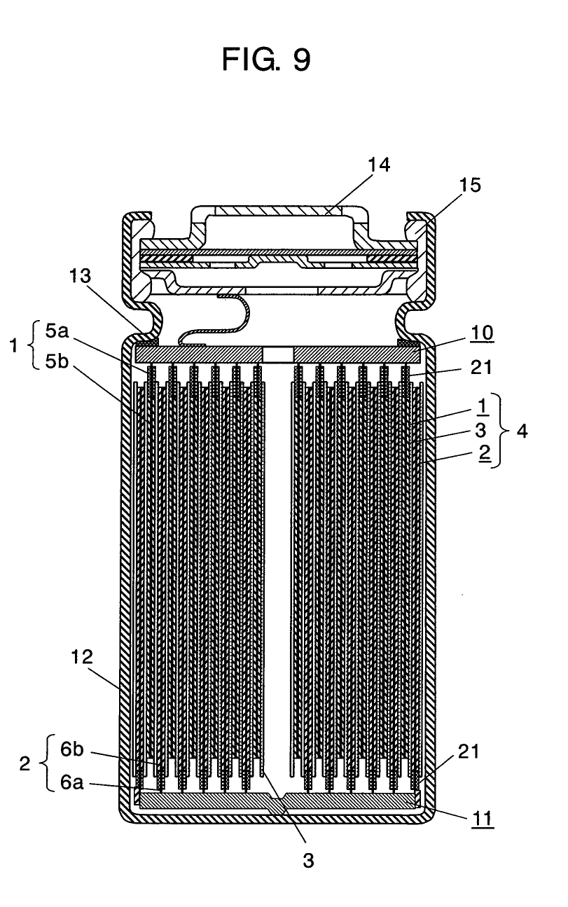

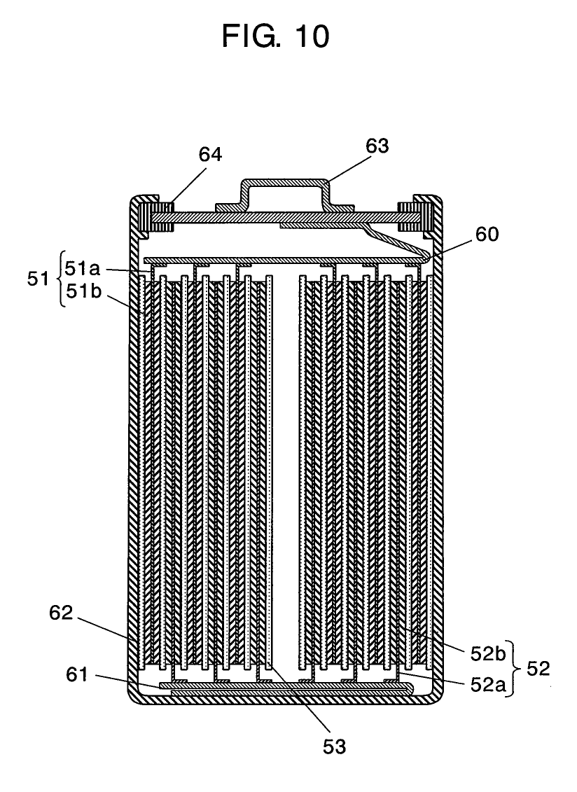

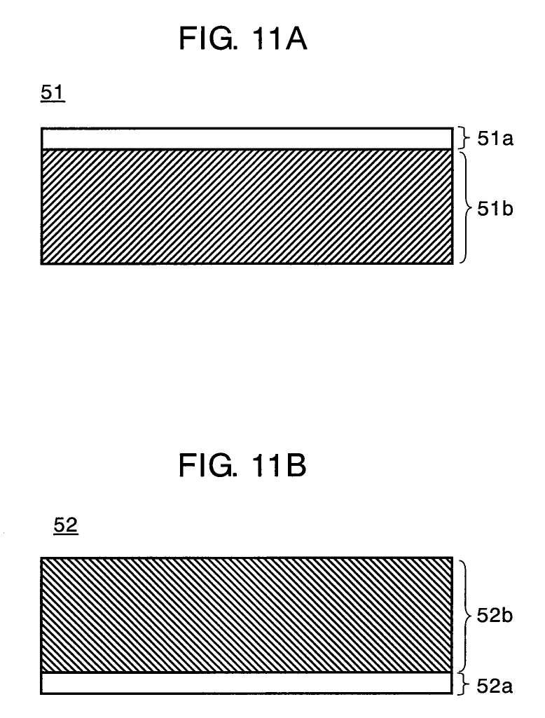

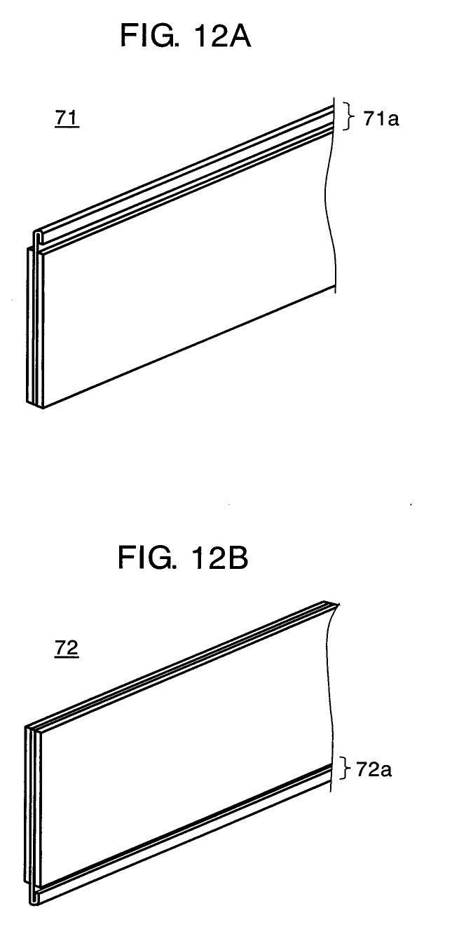

FIG. 8A is an expanded view of a positive electrode plate, and FIG. 8B is an expanded view of a negative electrode plate of a secondary battery according to the sixth exemplary embodiment of this invention. FIG. 9 is a sectional view showing a structure of the secondary battery according to this exemplary embodiment. The structure of the sixth exemplary embodiment is analogous to the first exemplary embodiment except only for the structure of the positive electrode plate and the negative electrode plate.

In other words, positive electrode plate 1 is provided with reinforcing layer 21 at least in the vicinity of a boundary between positive electrode activator composite coated area 5b and positive electrode activator composite uncoated area 5a, as shown in FIG. 8A. Likewise, negative electrode plates 2 is provided with reinforcing layer 21 at least in the vicinity of a boundary between negative electrode activator composite coated area 6b and negative electrode activator composite uncoated area 6a, as shown in FIG. 8B.

Description is provided here of a method of forming reinforcing layers 21. First, an inorganic oxide filler such as alumina, a binder, and a suitable amount of N-methyl-2-pyrrolidone (hereinafter referred to as “NMP”) are mixed to make a slurry. The slurry is coated on the boundary between positive electrode activator composite coated area 5b and positive electrode activator composite uncoated area 5a as well as the boundary between negative electrode activator composite coated areas 6b and negative electrode activator composite uncoated areas 6a, and dried to form reinforcing layers 21. It is desirable in this embodiment that reinforcing layers 21 are formed in a thickness equal to or less than that of positive electrode activator composite coated area 5b and negative electrode activator composite coated area 6b.

According to this sixth exemplary embodiment, the provision of reinforcing layers 21 can prevent weakening in the physical strength of the exposed portions of the current collectors. In addition, this embodiment can further improve the yield of manufacturing secondary batteries since reinforcing layers 21 can prevent positive electrode activator composite uncoated area 5a and negative electrode activator composite uncoated area 6a from being bent when they are being connected.

Description is provided hereinafter of some concrete examples according to the individual exemplary embodiments of the present invention.

### Embodied Sample, No. 1

Embodied sample 1 is an example representing the first exemplary embodiment discussed above.

To start with, a positive electrode plate capable of inserting and extracting lithium ions was produced according to the following method.

For preparation of a positive electrode activator composite, 85 parts by weight of lithium cobalt oxide powder, 10 parts by weight of carbon powder as an electric conductive material, and an NMP solution of poly-vinylidene fluoride (“PVDF”, of which a content is equivalent to 5 parts by weight) as a binder were mixed together.

Next, the composite material obtained above was coated by using a doctor blade method on a positive electrode activator composite coated area having a 50 mm width on both surfaces of a positive electrode current collector of an aluminum foil of 15 μm in thickness by 56 mm in width. After the composite material was dried, it was rolled to finish the positive electrode plate provided with a positive electrode activator composite uncoated area of 150 μm in thickness and 6 mm in width.

In addition, a negative electrode plate capable of inserting and extracting lithium ions was produced according to the following method.

First, as a negative electrode activator composite, 95 parts by weight of synthetic graphite powder and an NMP solution of PVDF (a content equivalent to 5 parts by weight) as a binder were mixed together.

Next, the composite material obtained above was coated by using a doctor blade method on a negative electrode activator composite coated area having a 52 mm width on both surfaces of a negative electrode current collector of a copper foil of 10 μm in thickness by 57 mm in width. After the composite material was dried, it was rolled to finish the negative electrode plate provided with a negative electrode activator composite uncoated area of 140 μm in thickness and 5 mm in width.

The positive electrode plate and the negative electrode plate produced in the above manner were wound into a spiral form with a separator comprised of a 25 μm thick micro-porous film made of polypropylene interposed therebetween, to produce an electrode assembly of a cylindrical configuration.

Inner diameter retainers of a cylindrical tube measuring 4.8 mm in outer diameter, 4.4 mm in inner diameter and 3 mm in height and ring frames measuring 25.5 mm in outer diameter, 24 mm in inner diameter and 3 mm in height were fitted to the center of winding axis having a 5 mm diameter as well as the outer periphery at both ends of the wound electrode assembly, from which the positive electrode activator composite uncoated area of the positive electrode current collector and the negative electrode activator composite uncoated area of the negative electrode current collector protrude. In addition, spring members of a wedge-like shape measuring 0.2 mm in thickness and 3 mm in height were disposed at least in positions intermediate between the inner periphery and the outer periphery of the electrode assembly where they are to be connected to a positive electrode current collector member and a negative electrode current collector member. Subsequently, the positive electrode current collector member made of a circular shape aluminum plate having an outer diameter of 25.5 mm and a thickness of 0.5 mm and the negative electrode current collector member made of a circular shape copper plate having an outer diameter of 25.5 mm and a thickness of 0.3 mm were welded by means of TIG welding to the respective current collectors at the positions where the spring members were disposed to the electrode assembly. Welding conditions used for the TIG welding in this instance were a current of 100 A and a time of 100 msec for the positive electrode, and a current of 130 A and a time of 50 msec for the negative electrode.

The obtained electrode assembly was inserted into a cylindrical battery case having an opening at one side (made of a nickel plated steel, 26 mm in diameter and 65 mm in height) with an insulation sheet placed between the battery case and the electrode assembly. After the negative electrode current collector member was resistance-welded to the battery case, the positive electrode current collector member was laser-welded to a sealing plate to complete assembly of the battery case.

Next, a nonaqueous solvent was prepared by mixing ethylene carbonate and ethyl-methyl carbonate at a volume ratio of 1 to 1. A nonaqueous electrolyte material was then produced by dissolving a solute of lithium hexafluoro-phosphate (“LiPF₆”) into the above solvent till it became 1 mol/L.

After the completed battery case was dried by heating it to 60° C. under a vacuum ambient, it was filled with the nonaqueous electrolyte material adjusted above.

The battery case was then sealed by crimping it with the sealing plate through a gasket, and this completed a cylindrical secondary battery of 26 mm in diameter, 65 mm in height and 2600 mAh in the design capacity. Secondary batteries thus produced were referred to as sample number 1.

### Embodied Sample, No. 2

Embodied sample 2 is an example representing the second exemplary embodiment discussed above.

First, a positive electrode current collector member made of a circular shape aluminum plate having an outer diameter of 25.5 mm, a thickness of 0.5 mm and provided with a through hole of 5 mm in diameter in the center thereof, and a negative electrode current collector member made of a circular shape copper plate having an outer diameter of 25.5 mm, a thickness of 0.3 mm and provided with a through hole of 5 mm in diameter in the center thereof were each processed to form a rib of 1 mm in height at both the inner periphery and the outer periphery along the winding direction of an electrode assembly.

The positive electrode current collector member and the negative electrode current collector member were disposed to both sides of the electrode assembly produced by using the same method as the sample number 1 by fitting the ribs to the inner periphery and the outer periphery of the electrode assembly, and the positive electrode current collector member and the negative electrode current collector member were then TIG welded to a positive electrode activator composite uncoated area and a negative electrode activator composite uncoated area respectively of the electrode assembly. Secondary batteries were thus produced in the same manner as the sample number 1 except for the above, and they were referred to as sample number 2.

### Embodied Sample, No. 3

Embodied sample 3 is an example representing the third exemplary embodiment discussed above.

Shrinkable ring bands made of polyolefine having an outer diameter of 25.5 mm and a thickness of 0.1 mm were attached to the outer peripheries of a positive electrode activator composite uncoated area and a negative electrode activator composite uncoated area at both sides of an electrode assembly produced by using the same method as the sample number 1, and they were heated at 150° C. to form bend preventing parts. Secondary batteries were then produced in the same manner as the sample number 1 except for the above, and they were referred to as sample number 3.

### Embodied Sample, No. 4

Embodied sample 4 is an example representing the fourth exemplary embodiment discussed above.

Clamping bands made of polypropylene having a width of 3 mm and a length of 80 mm were attached to the outer peripheries of a positive electrode activator composite uncoated area and a negative electrode activator composite uncoated area at both sides of an electrode assembly produced by using the same method as the sample number 1, and the bands were tightened to form bend preventing parts. Secondary batteries were then produced in the same manner as the sample number 1 except for the above, and they were referred to as sample number 4.

### Embodied Sample, No. 5

Embodied sample 5 is an example representing the fifth exemplary embodiment discussed above.

Push-nut type rings made of polypropylene having an outer diameter of 25.5 mm were attached to the outer peripheries of a positive electrode activator composite uncoated area and a negative electrode activator composite uncoated area at both sides of an electrode assembly produced by using the same method as the sample number 1. Projecting parts provided along their inner peripheries function as bend preventing parts. Secondary batteries were thus produced in the same manner as the sample number 1 except for the above, and they were referred to as sample number 5.

### Embodied Sample, No. 6

Embodied sample 6 is an example representing the sixth exemplary embodiment discussed above.

First, an inorganic oxide filler of alumina and a binder of polyacrylonitrile denatured rubber were mixed with an NMP solution, and made a slurry used for reinforcing layers.

After the slurry for reinforcing layers was coated on each portion of a positive electrode activator composite uncoated area conjoining a positive electrode activator composite coated area, into a size of 4 mm width and 67.5 μm thickness per each side, the coated slurry was dried to form the reinforcing layers. The reinforcing layers had thicknesses generally equal to that of the positive electrode activator composite coated area. Reinforcing layers of 4 mm width and 62 μm thickness were also formed on a negative electrode plate by using the same method.

Using the positive electrode plate and the negative electrode plate made by the above method, a secondary battery was produced in the same manner as the sample number 1 except for the above. Batteries thus produced were referred to as sample number 6.

### Comparison Sample, No. 1

Comparison sample 1 is an example embodied according to the patent document 2. That is, a positive electrode current collector and a negative electrode current collector were formed by folding a positive electrode activator composite uncoated area and a negative electrode activator composite uncoated area wound together. Secondary batteries were produced in the same manner as the sample number 1 except for the above, and they were referred to as sample C1.

The following evaluation was carried out on 50 pieces each of the sample secondary batteries produced in the above manner. Table 1 shows an overall result of the evaluation of the sample 1 through sample 6 and sample C1.

TABLE 1

| | Bend | | | | | | |
|---|---|---|---|---|---|---|---|
| | Preventing | Electrode | Tensile | Internal Resistance | | | Output |
| | Part | Shape | Strength | Value | | Variation | Current |
| Sample 1 | Spring | Normal | ≧50N | 5 | mΩ | 10% | 540 A |
| | member | | | | | | |
| Sample 2 | Rib | Normal | ≧50N | 5 | mΩ | 10% | 540 A |
| Sample 3 | Shrinkable | Normal | ≧50N | 5.8 | mΩ | 5% | 465 A |
| | ring band | | | | | | |
| Sample 4 | Clumping | Normal | ≧50N | 5.8 | mΩ | 5% | 465 A |
| | band | | | | | | |
| Sample 5 | Push-nut type | Normal | ≧50N | 5.8 | mΩ | 5% | 465 A |
| | ring | | | | | | |
| Sample 6 | Reinforcing | Normal | ≧50N | 5.8 | mΩ | 5% | 465 A |
| | layer | | | | | | |
| Sample C1 | None | Damage & | ≧10N | 11 | mΩ | 20% | 245 A |
| | | separation | (3/5) | | | | |
| | | of activator | | | | | |
| | | composite | | | | | |

First, the electrode assemblies of the secondary batteries produced were taken out of the battery cases, and they were visually examined for conditions of bending of the electrode plates. The examined results were shown in the column titled “Electrode Shape” in Table 1.

There were no bending of such an extent that causes a distortion in the activator composite on any of the secondary batteries in the groups of sample 1 to sample 6, as shown in Table 1. Although some of the samples exhibited small deformations of the electrode plates, such deformations are considered to be attributed to the current collector members, which were brought into abutment on the sides of the electrode assemblies during the welding processes. Therefore, none of the batteries of sample 6 did not show any bend of their electrode plates since these batteries are provided with the reinforcing layers. On the other hand, separations and damages of the activator composites were observed on many batteries of sample C1 due to bending of the electrodes around the boundaries between the coated areas and uncoated areas of the activator composite.

Furthermore, five pieces of the batteries were selected from each sample group, and they were each subjected to measurement of a tensile strength in the welded portion according to JIS Z2241 standard. To be more specific, the electrode assembly was held on one side of a tension tester, and the current collector member was held on the other side of the tension tester. The electrode assembly and the current collector member in this setting were pulled at a constant speed in an axial direction of the tension tester. A tension applied to the sample was taken as the tensile strength when the welded portion was broken. The results of measurement were recorded in the column titled “Tensile Strength” in Table 1.

Every battery in the groups of sample 1 to sample 6 exhibited a tensile strength of 50N or greater as shown in Table 1. On the other hand, three out of five batteries in the group of sample C1 exhibited tensile strengths of 10N or less, and their welding were found broken.

In addition, an internal resistance was measured on every battery of sample 1 to sample 6 and sample C1. To be more concrete, each sample was subjected to three repeated operations of a charge-and-discharge cycle, which consists of charging the sample up to 4.2V with a constant current of 1250 mA, followed by discharging down to 3.0V with a constant current of 1250 mA. After the above, an internal resistance of the secondary battery was measured by applying an AC voltage of 1 kHz to each sample, and the connection was evaluated. The results of measurement were shown in the column titled “Internal Resistance” in Table 1.

As shown in Table 1, a mean value of the internal resistances was 5 mΩ with variations of approximately 10% for the batteries of sample 1 and sample 2. A mean value of the internal resistances was 5.8 mΩ with variations of about 5% for the batteries of sample 3 to sample 6.

On the other hand, the batteries of sample C1 showed a mean internal resistance value of 11 mΩ, and variations of 20%.

In addition, an average output current (“I”) was calculated from the measured value of internal resistance (“R”) for each group of the samples. Concretely, the output current can be calculated by the formula of I=(4.2−1.5)/R when the battery is discharged to 1.5V after it is charged up to 4.2V. The result is shown in the column titled “Output Current” in Table 1.

It was found that the batteries of sample 1 to sample 6 are capable of discharging large currents, as shown in Table 1.

In each of the exemplary embodiments, the secondary battery was illustrated using the example, in which the inner diameter retainer is inserted in the center of the winding axis of the electrode assembly. However, the battery exhibited the similar advantageous effect without any specific problem even when the inner diameter retainer was omitted.

On the other hand, the advantageous effect of the present invention was not achieved in any of the secondary batteries, when the bend preventing part was constructed only of the inner diameter retainer discussed in the above exemplary embodiments. Those batteries showed developments of bending of the current collectors and separation of the activator composite in the coated areas.

Although the above exemplary embodiments covered the batteries of cylindrical shape, this invention should not be considered as to be restrictive. The present invention can be embodied or practiced in other forms of secondary batteries such as rectangularly-shaped batteries, nickel hydrogen batteries and nickel-cadmium batteries, for example, to obtain the like advantages.

### INDUSTRIAL APPLICATION

A battery of the present invention comprises a bend preventing part for providing uniform and reliable connections between individual current collector members and corresponding current collectors respectively shown as activator composite uncoated areas, and for preventing separation of the activator composite from the current collectors. The invention thus achieves the connections of low resistance to allow charging and discharging of the battery with a large current, thereby making the battery useful for driving a power tool and an electric vehicle which require high power, and a large demand of which is anticipated in the future.

1. A secondary battery at least comprising:
an electrode assembly having a positive electrode plate, a negative electrode plate and a porous insulation layer arranged in a manner that an exposed portion of a current collector provided at one edge of at least one of the positive electrode plate and the negative electrode plate protrudes from the porous insulation layer;
current collector members, each connected to respective one of the positive electrode plate and the negative electrode plate; and
a bend preventing part whose size smaller than a width of the exposed portion of the current collector, the bend preventing part provided in a position of the exposed portion of the current collector.

2. The secondary battery of claim 1, wherein the bend preventing part comprises a ring frame fitted to an outer periphery of the electrode assembly, and a spring member of a wedge-like shape inserted in an intermediate position of the exposed portion of the wound current collector.

3. The secondary battery of claim 1, wherein the bend preventing part comprises the current collector member provided with ribs, each fitted to an outer periphery and an inner periphery of the exposed portion of the current collector.

4. The secondary battery of claim 1, wherein the bend preventing part comprises a shrinkable ring band fitted to an outer periphery of the electrode assembly, the shrinkable ring band collectively aligns the exposed portion of the current collector when shrunk thermally.

5. The secondary battery of claim 1, wherein the bend preventing part comprises a clamping band attached to an outer periphery of the electrode assembly, the clamping band collectively aligns the exposed portion of the current collector when tightened.

6. The secondary battery of claim 1, wherein the bend preventing part comprises a push-nut type ring attached to an outer periphery of the electrode assembly, the push-nut type ring having a plurality of projecting parts formed along an inner periphery thereof for collectively aligning the exposed portion of the current collector.

7. The secondary battery of claim 1, wherein the bend preventing part comprises a reinforcing layer formed on any of the positive electrode plate and the negative electrode plate along a boundary between the exposed portion of the current collector and an activator composite coated area.

8. The secondary battery claim 1, wherein the bend preventing part comprises an inner diameter retainer disposed on the electrode assembly.
